(19) United States
(12) Patent Application Publication
(10) Pub. No.: US 2026/0298881 A1
(43) Pub. Date: Oct. 1, 2026

(54) OPTICAL MACHINE ULTRASONIC SENSOR HAVING ADJUSTABLE SENSITIVITY AND DYNAMIC AREA AND METHOD FOR CONTROLLING SAME

(71) Applicant: DAEGU GYEONGBUK INSTITUTE OF SCIENCE AND TECHNOLOGY, Daegu (KR)

(72) Inventors: Jae Sok YU, Daegu (KR); Sang Yoon HAN, Daegu (KR); Sang Woo NAM, Suwon-si (KR); Dong Ju CHOI, Daegu (KR)

(21) Appl. No.: 19/480,072

(22) PCT Filed: Mar. 13, 2024
(86) PCT No.: PCT/KR2024/003229

§ 371 Date: Oct. 30, 2025

(30) Foreign Application Priority Data
May 4, 2023 (KR) 10-2023-0058390
Aug. 23, 2023 (KR) 10-2023-0110462

(51) Int. Cl. G01N 29/24; G01N 29/04

(52) U.S. Cl. CPC G01N 29/24; G01N 29/04

(57) ABSTRACT

The present disclosure relates to an ultrasonic sensor and a method for operating same. More specifically, the present disclosure relates to an optical machine ultrasonic sensor, the sensitivity and dynamic area of which can be adjusted by adjusting the initial position of a membrane of a cantilever structure, and a method for controlling same.

### TECHNICAL FIELD

The present disclosure relates to an ultrasonic sensor and a method for operating same, and more particularly, to an optomechanical ultrasonic sensor in which the sensitivity and dynamic range can be adjusted by adjusting an initial position of a membrane of a cantilever structure, and a method for controlling same.

### BACKGROUND ART

Currently, ultrasonic non-destructive testing is essential in various industrial fields, including the semiconductor industry and the secondary-battery industry. Such non-destructive testing evaluates the presence of abnormalities and defects by examining the properties, states, and internal structures of products using physical energy without altering the original form or function of the products, and can improve accuracy by acquiring high-frequency signals with high sensitivity and being relatively free from disturbances caused by electromagnetic interference (EMI).

Optical ultrasonic sensors exhibit higher accuracy than conventional piezoelectric-element-based ultrasonic sensors (PZT) because of their high sensitivity. However, since the photoacoustic signals detectable by optical ultrasonic sensors have low amplitude and a wide bandwidth, sensors with high sensitivity and high bandwidth are required to detect such signals.

### DISCLOSURE OF INVENTION

### Technical Problem

The present disclosure is directed to providing an optomechanical ultrasonic sensor in which sensitivity is adjustable by controlling an applied electrical signal, and a method for controlling same.

The present disclosure is further directed to providing an optomechanical ultrasonic sensor in which dynamic range is adjustable by controlling an applied electrical signal, and a method for controlling same.

The present disclosure is not limited to what has been described above, and other aspects not mentioned herein will be apparent from the following description to one of ordinary skill in the art to which the present disclosure pertains. Moreover, aspects of the present disclosure may be realized by the means and combinations thereof indicated in claims.

### Solution To Problem

One embodiment of the present disclosure provides an ultrasonic sensor including a membrane having a cantilever structure configured to vibrate about an axis at one end in response to external sound pressure, the membrane having an initial vibration position adjusted by an electrical signal, a first optical waveguide configured to allow light to pass and including a first path positioned on the membrane, an optical transmitter configured to couple light into the first optical waveguide, and a second optical waveguide spaced apart from the membrane and including a second path through which at least a portion of light passing through the first path propagates.

The present disclosure provides an ultrasonic sensor further including an electrode positioned on the membrane and configured to receive the electrical signal.

The present disclosure further provides a method for controlling an ultrasonic sensor, the method including adjusting an initial vibration position of a membrane by applying a voltage signal to an electrode, the membrane having a cantilever structure configured to vibrate about an axis at one end, coupling light into a first optical waveguide including a first path positioned on the membrane, and measuring an intensity of light propagated in a second optical waveguide, the second optical waveguide being spaced apart from the membrane and including a second path through which at least a portion of light passing through the first path propagates, wherein the measuring the intensity of the propagated light includes measuring an intensity of the propagated light that varies as the membrane vibrates about the axis at the one end in response to external sound pressure to be measured.

Other aspects and features than those described above will become apparent from the following drawings, claims, and detailed description of the present disclosure.

### Advantageous Effects

According to the present disclosure, the sensitivity and dynamic range of the ultrasonic sensor may be adjusted by controlling an electrical signal applied to the sensor.

Effects of the present disclosure are not limited to those mentioned above, and other effects not mentioned may be clearly understood by those skilled in the art from the following description.

### BRIEF DESCRIPTION OF DRAWINGS

FIG. 1 is a diagram illustrating an environment for operating an ultrasonic sensor according to one embodiment of the present disclosure.

FIG. 2 is a plan view of an ultrasonic sensor according to one embodiment of the present disclosure.

FIG. 3 is a diagram showing in greater detail the portion indicated by the dotted line in FIG. 2, and illustrating light propagation according to one embodiment of the present disclosure.

FIG. 4 is a side view of an ultrasonic sensor according to one embodiment of the present disclosure.

FIG. 5 is a diagram illustrating one embodiment in which an initial position of a membrane is adjusted by applying electrical signals of 5 V and 2 V according to one embodiment of the present disclosure.

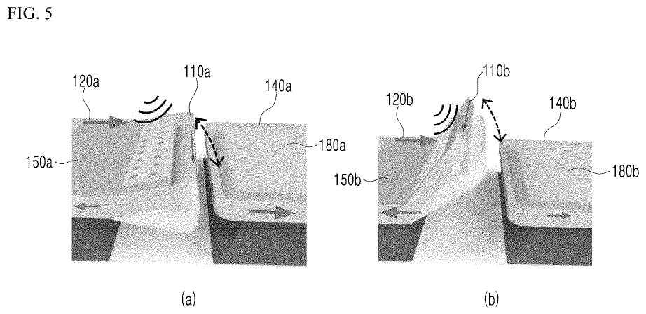

FIG. 6 shows experimental results when electrical signals of 5 V and 2 V are applied according to one embodiment of the present disclosure, wherein (a) is a graph showing the intensity of an optical signal measured versus ultrasonic frequency, and (b) is a graph comparing sensitivity between the two cases.

FIG. 7 is a diagram illustrating a process flow for manufacturing an ultrasonic sensor according to one embodiment of the present disclosure.

FIG. 8 is a flowchart of a method for controlling an ultrasonic sensor according to one embodiment of the present disclosure.

### BEST MODE FOR CARRYING OUT THE INVENTION

Embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description may be omitted. Furthermore, it should be understood that the appended drawings are intended only to help understand embodiments disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms first, second, and the like may be used herein to describe various elements, these elements should not be limited by these terms. These terms are only used to distinguish one element from another.

When an element is referred to as being “connected to” or “coupled to” another element, it may be directly connected or coupled to the other element, or intervening elements may be present. In contrast, when an element is referred to as being “directly connected to” or “directly coupled to” another element, there may be no intervening elements or layers present.

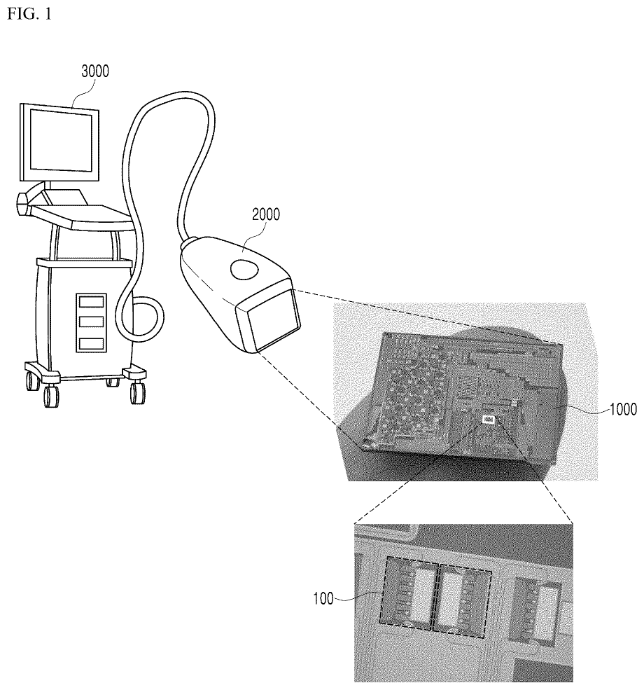

Referring to FIG. 1, an environment for operating an ultrasonic sensor according to one embodiment of the present disclosure is described.

The ultrasonic sensor according to one embodiment of the present disclosure may be included in a sensor unit 1000 of an ultrasonic probe 2000 that is electrically or mechanically connected to an ultrasonic non-destructive testing apparatus 3000 during operation. The sensor unit 1000 may include a plurality of cells, each cell being an optomechanical ultrasonic sensor 100 with adjustable sensitivity and dynamic range according to the embodiments described below, and each cell may convert detected ultrasonic sound pressure into an electrical signal.

The sensor unit 1000 may include a plurality of optical waveguides, and a plurality of cells 100 including the optical waveguides may be optically interconnected. Each cell 100 may include two optical waveguides, each including a path parallel to a membrane having a cantilever structure, as described in detail below.

According to one embodiment, components such as the optical waveguides and the membrane of the ultrasonic sensor 100 may be implemented on a substrate through semiconductor processes such as deposition, photolithography, etching, and lift-off. Accordingly, a cell array structure including multiple cells may be manufactured in a very small area, and the cell array may be connected to optical circuits and electrical circuits integrated on a substrate to configure a small-sized ultrasonic sensor unit 1000.

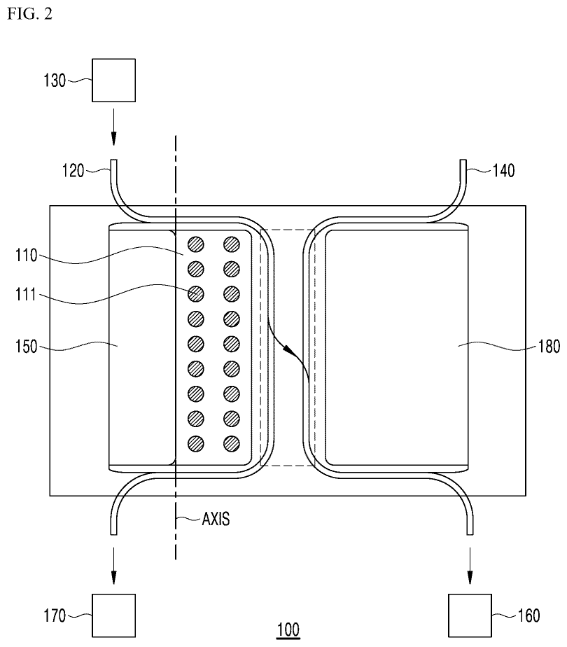

The configuration of the ultrasonic sensor 100 according to one embodiment of the present disclosure will be described with reference to FIG. 2. FIG. 2 may illustrate a single cell of the sensor unit 1000 or may mean that the sensor unit 1000 itself is configured as a single cell.

The ultrasonic sensor 100 according to one embodiment of the present disclosure may include a membrane 110 having a cantilever structure configured to vibrate about an axis at one end in response to external sound pressure, the membrane 110 having an initial vibration position adjustable by an electrical signal, a first optical waveguide 120 configured to allow light to pass and including a first path 121 positioned on the membrane, an optical transmitter 130 configured to couple light into the first optical waveguide, and a second optical waveguide 140 spaced apart from the membrane and including a second path 141 through which at least a portion of light passing through the first path propagates.

The membrane 110 may have a resonance frequency, and may be in the form of a cantilever structure configured to vibrate in a direction perpendicular to a substrate in response to external sound pressure. In another embodiment, the membrane 110 may include cavities 111. The cavities 111 may allow an etching gas (for example, hydrogen fluoride (HF) gas) to pass during a manufacturing process of the ultrasonic sensor 100. The frequency characteristics of the membrane 110 may be determined by formation of the cavities 111.

According to one embodiment of the present disclosure, an electrode 150 may be positioned on the membrane 110. The electrode 150 may be a metallic component and may be implemented by depositing a metal such as Au or Cr, for example. According to one embodiment of the present disclosure, an initial vibration position of the membrane 110 may be adjusted by applying an electrical signal to the electrode 150. For this purpose, the membrane 110 may be configured such that a degree of deflection is adjusted in response to the electrical signal. As the initial position of the membrane 110 is adjusted, both the dynamic range of its vibration and the sensitivity of the ultrasonic sensor 100 to ultrasound at a predetermined frequency may be adjusted.

The first optical waveguide 120 configured to allow light to pass includes a first path 121 positioned on the membrane 110. In one embodiment, the first path 121 may be positioned at a predetermined distance from the axis, and, because it is formed at a location other than the axis of vibration, the position of the first path 121 may change as the membrane 110 vibrates. Alternatively, the first path 121 may be positioned at an end of the membrane 110 corresponding to the axis. In this case, the first path 121 may be formed along the periphery of the membrane 110, and the first optical waveguide 120 may include a portion formed along the periphery of a region of the membrane 110 that vibrates.

The second optical waveguide 140, like the first optical waveguide 120, is configured to allow light to pass. The second optical waveguide 140 includes a second path 141 through which at least a portion of light passing through the first path propagates. In one embodiment, the second path 141 may be spaced apart from the membrane 110 and may remain fixed during ultrasound reception, and to this end, the second path 141 may be disposed on a fixed portion 180 that remains fixed during ultrasound reception.

As described above, the first optical waveguide 120 includes the first path 121, and the second optical waveguide 140 includes the second path 141, which is parallel to the first path 121. The first path 121 and the second path 141 may be positioned with a separation distance that allows light to propagate between them, and in one embodiment, the separation distance between the first path 121 and the second path 141 may be set to be not less than 150 nm and not greater than 250 nm. The first path 121 and the second path 141 may be linear, and the first path 121 and the second path 141 may be parallel to each other with a predetermined separation distance therebetween. Since the second path 141 does not change position while the membrane 110 vibrates in response to external sound pressure, the separation distance between the first path 121 and the second path 141 changes in accordance with vibration of the membrane 110, and an intensity of light propagated from the first path 121 to the second path 141 also changes.

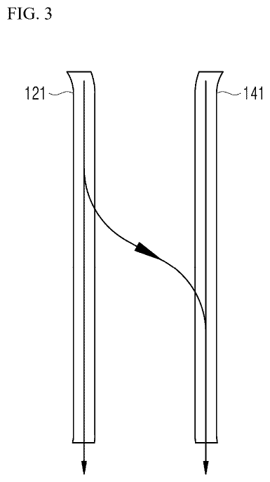

FIG. 3 is a diagram showing in detail the portion indicated by the dotted line in FIG. 2, illustrating propagation to the second path 141 of at least a portion of light that passes through the first path 121. When external sound pressure is applied, the first path 121 vibrates in a direction perpendicular to the substrate according to the vibration of the membrane 110, and since the second path 141 is spaced apart from the membrane 110 and fixed, the separation distance between the first path 121 and the second path 141 changes in accordance with the vibration. Here, when the separation distance increases, light propagated from the first path 121 to the second path 141 decreases, and when the separation distance decreases, light propagated from the first path 121 to the second path 141 increases. Accordingly, an ultrasonic signal can be detected by detecting light propagated from an end of the second optical waveguide and converting the light into an electrical signal.

The ultrasonic sensor 100 according to one embodiment of the present disclosure may further include an optical receiver 160 configured to measure an intensity of light propagated from one end of the second optical waveguide. The optical receiver 160 may detect an intensity of light propagated to the second path 141 in the second optical waveguide, and may thereby detect an intensity of light propagated in response to vibration of the membrane 110. Remaining light that is not propagated may enter a dump 170.

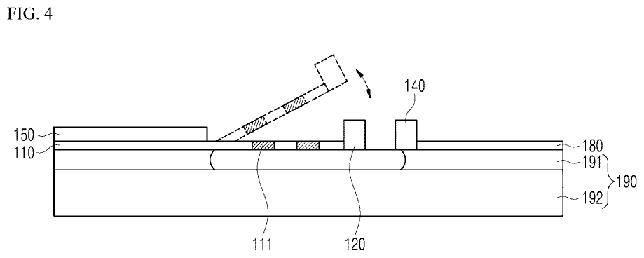

Referring to FIG. 4, a side structure of the ultrasonic sensor 100 according to one embodiment of the present disclosure is described. FIG. 4 is a side view of the ultrasonic sensor 100 of FIG. 2, and redundant descriptions are omitted.

A layered structure of the ultrasonic sensor 100 according to one embodiment of the present disclosure may be implemented through semiconductor processes such as deposition, photolithography, etching, and lift-off.

The ultrasonic sensor 100 may be positioned on a substrate 190. The substrate 190 may be an SOI substrate having a structure in which a SiO₂ layer 191 is formed on a Si substrate 192. The ultrasonic sensor 100 includes a membrane 110 having a cantilever structure configured to vibrate in response to external sound pressure, and a fixed portion 180. Because the membrane 110 has a cantilever structure with one end as an axis, the membrane 110 may vibrate in a direction perpendicular to the substrate 190 in response to external sound pressure.

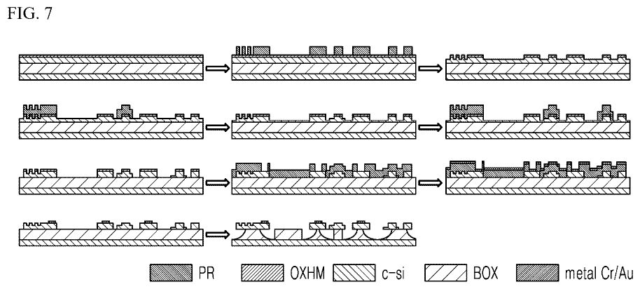

According to one embodiment, during a manufacturing process of the ultrasonic sensor 100, the cantilever structure may be formed by partially etching the layer 191 through cavities 111 formed in the membrane 110, and the manufacturing process of the ultrasonic sensor 100 is described in detail with reference to FIG. 7. The electrode 150 may be a metal component such as gold (Au) or chromium (Cr), but is not limited thereto.

FIG. 4 is a diagram illustrating adjustment of an initial vibration position of the membrane 110 by applying an electrical signal according to one embodiment of the present disclosure.

According to one embodiment, when no electrical signal is applied, the initial position of the membrane 110 may be positioned higher than the fixed portion 180 in a direction perpendicular to the substrate 190. At this time, by applying an electrical signal to the electrode 150, a potential difference is generated between the membrane 110 and the fixed portion 180, and as a result, the initial position of the membrane 110 may be positioned closer to the fixed portion 180.

In FIG. 4, (a) illustrates application of a high-voltage electrical signal, and (b) illustrates application of a relatively low-voltage electrical signal. When a high-voltage electrical signal is applied, a large potential difference occurs between the membrane 110 and the fixed portion 180, so that the initial position of the membrane 110 may be adjusted to be lower than when a low voltage is applied.

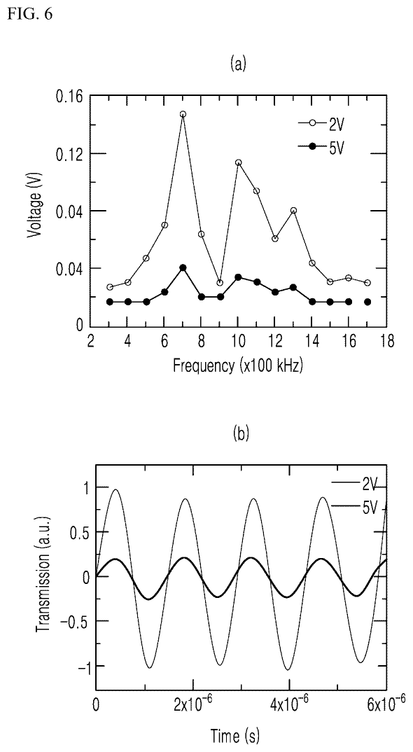

FIG. 6 shows results of detecting ultrasound through the ultrasonic sensor 100 when DC voltages of 2 V and 5 V are applied to the electrode 150, as an experimental example of the present disclosure.

In FIG. 6, (a) shows measurement of the intensity of an optical signal detected according to ultrasonic frequency (300 kHz-1700 kHz), and (b) compares sensitivities for 2 V and 5 V. In (b), a frequency of 700 kHz with a sound pressure of 44.2 Pa was used, and the sensitivities were 3.4 mV/Pa for 2 V and 0.9 mV/Pa for 5 V, respectively.

A manufacturing method for the ultrasonic sensor 100 according to one embodiment of the present disclosure is described with reference to FIG. 7. The optical waveguides and the membrane of the ultrasonic sensor according to one embodiment of the present disclosure may be implemented on a substrate through semiconductor processes such as deposition and etching, and may be formed into a cell array structure including a plurality of cells in a very small area patterned at the nanoscale. The cell array may be connected to optical circuits and electrical circuits integrated on the substrate to configure a small-sized ultrasonic sensor unit.

FIG. 7 is a diagram illustrating a manufacturing process flow for an ultrasonic sensor according to one embodiment of the present disclosure. As shown in FIG. 7, the ultrasonic sensor may be manufactured on an SOI substrate through photolithography-based semiconductor processes. In a specific embodiment, the ultrasonic sensor is manufactured by depositing an OXHM on the SOI substrate, performing PR patterning, and repeatedly partially etching the Si layer to implement the membrane 110 including the cavities 111, the fixed portion 180, and the optical waveguides 120 and 140. Thereafter, after PR patterning, a metal is deposited, and the electrode 150 is formed through a lift-off process.

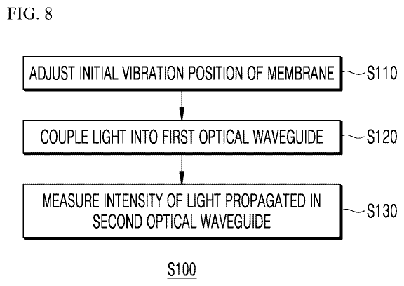

A method for controlling an ultrasonic sensor according to one embodiment of the present disclosure is described with reference to FIG. 8.

The method for controlling an ultrasonic sensor according to one embodiment of the present disclosure may include adjusting an initial vibration position of the membrane S110, coupling light into the first optical waveguide including the first path positioned on the membrane S120, and measuring an intensity of light propagated in the second optical waveguide S130.

In S110, an initial vibration position of the membrane is adjusted. The membrane 110 may have a cantilever structure configured to vibrate about an axis at one end in response to external sound pressure. A degree of deflection of the membrane may be adjusted according to an applied electrical signal. An electrode may be positioned on the membrane, and the initial position of the membrane may be adjusted by applying the electrical signal to the electrode.

In S120, light is coupled into the first optical waveguide. The first optical waveguide includes a first path positioned on the membrane, and in one embodiment, the first path may be positioned at an end of the membrane distal from the axis, and at least a portion of the first optical waveguide may extend along the periphery of the membrane.

In S130, an intensity of light propagated in the second optical waveguide 140 is measured. The second optical waveguide 140 includes the second path 141 positioned on the fixed portion 180, and the first path 121 and the second path 141 may each be linear and arranged in parallel. In one embodiment, a separation distance between parallel portions of the first path 121 and the second path 141 may be set to be not less than 150 nm and not greater than 250 nm, light passing through the first path 121 may propagate to the second path 141, and the arrangement may be designed to be suitable for detecting ultrasonic vibration resulting from vibration of the membrane 110.

The present disclosure may be implemented as a computer-readable code in a medium with a program recorded therein. The computer-readable medium may include all kinds of recording devices in which computer-readable data is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, or the like. In addition, the computer may include a processor for each component or device.

The programs may be specially designed and constructed for the purposes of the present disclosure or they may be of a type well known and available to those skilled in the computer software arts. Examples of computer programs may include both machine code, such as that produced by a compiler, and higher-level language code that may be executed by the computer using an interpreter or the like.

As used in the present disclosure (especially in the appended claims), the terms “a/an” and “the” include both singular and plural references, unless the context clearly states otherwise. Also, it may be understood that any numerical range recited in the present disclosure is intended to include (e.g., all) sub-ranges subsumed therein (unless indicated otherwise) and accordingly, the disclosed numeral ranges include (e.g., every) individual value between the minimum and maximum values of the numeral ranges.

The method according to the present disclosure may be performed in an appropriate order unless a specific order is described or otherwise specified. That is, the present disclosure is not limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it may be apparent to those skilled in the art that various modifications, combinations, and alternations may be made depending on design conditions and factors within the scope of the appended claims or equivalents thereof.

The present disclosure is thus not limited to the example embodiments described above, and rather the present disclosure is intended to include the claims, and modifications, equivalents, and alternatives falling within the spirit and scope of the appended claims.

### LIST OF REFERENCE NUMERALS

1000: Sensor unit
2000: Ultrasonic probe
3000: Ultrasonic non-destructive testing apparatus
100: Ultrasonic sensor
110: Membrane
120: First optical waveguide
130: Optical transmitter
140: Second optical waveguide
150: Electrode
160: Optical receiver
170: Dump
180: Fixed portion
190: Substrate

1. An ultrasonic sensor comprising:
a membrane having a cantilever structure configured to vibrate about an axis at one end in response to external sound pressure, the membrane having an initial vibration position adjusted by an electrical signal;
a first optical waveguide configured to allow light to pass and including a first path positioned on the membrane;
an optical transmitter configured to couple light into the first optical waveguide; and
a second optical waveguide spaced apart from the membrane and including a second path through which at least a portion of light passing through the first path propagates.

2. The ultrasonic sensor of claim 1, further comprising an electrode positioned on the membrane and configured to receive the electrical signal.

3. The ultrasonic sensor of claim 1, further comprising an optical receiver configured to measure, at one end of the second optical waveguide, an intensity of the propagated light.

4. The ultrasonic sensor of claim 1, wherein a degree of deflection of the membrane varies in response to an applied electrical signal.

5. The ultrasonic sensor of claim 1, wherein the first path is linear and the second path is linear and parallel to the first path.

6. The ultrasonic sensor of claim 5, wherein a separation distance between parallel portions of the first path and the second path is not less than 150 nm and not greater than 250 nm.

7. The ultrasonic sensor of claim 1, wherein the first path is linear and parallel to the axis.

8. The ultrasonic sensor of claim 1, wherein the first path is positioned at a predetermined distance from the axis, and the position of the first path changes as the membrane vibrates about the axis.

9. The ultrasonic sensor of claim 1, wherein at least a portion of the first optical waveguide extends along the periphery of the membrane, and the first path is positioned at an end of the membrane distal from the axis.

10. A method for controlling an ultrasonic sensor, the method comprising:
adjusting an initial vibration position of a membrane by applying a voltage signal to an electrode, the membrane having a cantilever structure configured to vibrate about an axis at one end;
coupling light into a first optical waveguide including a first path positioned on the membrane; and
measuring an intensity of light propagated in a second optical waveguide, the second optical waveguide being spaced apart from the membrane and including a second path through which at least a portion of light passing through the first path propagates,
wherein the measuring the intensity of the propagated light comprises measuring an intensity of the propagated light that varies as the membrane vibrates about the axis at the one end in response to external sound pressure to be measured.

11. The method of claim 10, wherein the adjusting the initial vibration position of the membrane comprises controlling a magnitude of a voltage signal applied to the membrane to adjust a degree of deflection of the membrane.

12. The method of claim 11, wherein a separation distance between parallel portions of the first path and the second path is not less than 150 nm and not greater than 250 nm.

13. The method of claim 10, wherein the first path is linear and parallel to an end of the membrane.

14. The method of claim 10, wherein the first path is positioned at a predetermined distance from the axis, and the position of the first path changes as the membrane vibrates about the axis at the one end of the membrane.

15. The method of claim 10, wherein at least a portion of the first optical waveguide extends along the periphery of the membrane, and the first path is positioned at an end of the membrane distal from the axis.
